(19) United States
(12) Patent Application Publication
(10) Pub. No.: US 2023/0358555 A1
(43) Pub. Date: Nov. 9, 2023

(54) NAVIGATION DEVICE, NAVIGATION SERVICE PROVIDING METHOD, AND NAVIGATION SERVICE PROVIDING SERVER

(71) Applicant: 42DOT INC., Seoul (KR)

(72) Inventors: Jin Ju YU, Yongin-si Gyeonggi-do (KR); Ji Hye SYNN, Seoul (KR)

(21) Appl. No.: 18/044,539

(22) PCT Filed: Sep. 8, 2021
(86) PCT No.: PCT/KR2021/012185

§ 371 Date: Mar. 8, 2023

(30) Foreign Application Priority Data
Sep. 8, 2020 (KR) 10-2020-0114797
Feb. 18, 2021 (KR) 10-2021-0021642

(51) Int. Cl. G01C 21/36; G01C 21/00

(52) U.S. Cl. CPC G01C 21/3602; G01C 21/3885; G01C 21/3667

(57) ABSTRACT

A navigation device in accordance with one embodiment may comprise a communication unit configured to send a driving image of a vehicle captured through at least one camera installed in the vehicle to an external terminal and to receive driving assistance information inputted by a user of the external terminal for the driving image and a control unit configured to output information generated based on the driving assistance information by controlling at least one of a display unit and a speaker.

### TECHNICAL FIELD

The present invention relates to a navigation device, a method for providing a navigation service, and a server for providing a navigation service, and more specifically, to a technology for sharing information on a vehicle currently being driven with an external terminal and notifying a user of driving information together with a navigation device installed in a vehicle by using information and images transmitted by the external terminal.

### BACKGROUND

A navigation device displays the current location of a moving object, such as a vehicle, or the like, on a map by using GPS signals received from a global positioning system (GPS). Such a navigation device is currently mounted on various moving objects such as ships, aircraft, vehicles, and the like, and is widely used to check the current location and moving speed of the moving object or to determine a moving route.

In general, a navigation device used in a vehicle searches for driving routes to a destination using map information when a user inputs the destination, and guides the vehicle along a driving route selected by the user. In addition, the navigation device provides guidance for the user to arrive at the destination by visually or audibly providing various information such as driving routes to the destination, terrain features located around the driving routes, a road congestion level, and so on.

On the other hand, when the guidance provided by a navigation device is used, often, it is difficult to find an exact route to go, or there are times of getting lost. In particular, it may be difficult to accurately determine whether to make a turn in this or the next alley only with the guidance provided in complex alleys. As a result, the driver often stops the vehicle for a while to compare the map provided by the navigation device with the actual location, or listens to an explanation of the route to the destination through a call connection with an acquaintance at the destination, and in such cases, many problems occur, such as not being able to arrive at the destination in time, causing traffic jams, or the like.

### SUMMARY OF INVENTION

### Technical Objects

A navigation device, a method for providing a navigation service, and a server for providing a navigation service in accordance with an embodiment are an invention devised to solve the problems described above, and there exists an object to improve the reliability of a navigation device by sharing the driving information of a vehicle and front-view images of the vehicle with an external user and receiving the guidance of a driving route more accurately from an external user who knows the route to a destination well.

A navigation device in accordance with one embodiment may comprise a communication unit configured to send a driving image of a vehicle captured through at least one camera installed in the vehicle to an external terminal and to receive driving assistance information inputted by a user of the external terminal for the driving image and a control unit configured to output information generated based on the driving assistance information by controlling at least one of a display unit and a speaker.

The driving assistance information may comprise display information inputted by a user of the external terminal for the driving image displayed on the external terminal, and the control unit may display the display information on the display unit together with the driving image displayed on the display unit.

The control unit may display first display information, obtained by transforming the driving assistance information into arrows or text, by superimposing or augmenting it over the driving image.

The control unit may display the display information by superimposing or augmenting it over the driving image, without transforming it.

The control unit may display driving route information for guiding the vehicle on the display unit.

The communication unit may send the driving route information to the external terminal, and the control unit may display driving assistance information inputted from the external terminal for the driving route information displayed on the external terminal together with the driving route information displayed on the display unit.

The control unit may output the voice information through a speaker if the driving assistance information is voice information,

The control unit may simultaneously display the driving image of the vehicle sent by the communication unit to the external terminal on the display unit. if the external terminal and the communication unit are connected,

A method for providing a navigation service in accordance with one embodiment may comprise receiving driving information of a vehicle and a driving image of the vehicle, and sending the driving image to an external terminal, receiving driving assistance information inputted to the external terminal for the driving image sent to the external terminal and generating a combined image obtained by combining the driving assistance information with the driving image, and sending the combined image to the vehicle or a user terminal providing a driving information service for the vehicle.

A server for providing a navigation service in accordance with one embodiment may comprise a communication unit configured to receive a driving image of a vehicle, to send the driving image to an external terminal, and then to receive driving assistance information inputted by the external terminal for the driving image and a control unit configured to generate a combined image obtained by combining the driving assistance information with the driving image, and to send, by using the communication unit, the combined image and driving route information for guiding the vehicle to the vehicle or a user terminal providing a driving information service for the vehicle.

### Effects of the Invention

According to the navigation device, the method for providing a navigation service, and the server for providing a navigation service in accordance with an embodiment, since a driver can receive guidance for a driving route from an external user while the user of an external terminal is viewing the same driving image, there is an effect of reducing the error between the current location recognized by the driver and a destination and of improving the reliability of the navigation device.

In addition, according to the navigation device, the method for providing a navigation service, and the server for providing a navigation service in accordance with an embodiment, there is an advantage that when a driver drives to a destination, he or she can receive guidance of voice information or input information from another person who knows the route to the destination well together, and thus, can drive to the destination more safely.

### BRIEF DESCRIPTION OF THE DRAWINGS

FIG. 1 is a diagram for illustrating the relationship between a navigation device and an external terminal.

FIG. 2 is a block diagram showing some components of a navigation device in accordance with an embodiment.

FIGS. 3A, 3B and 3C are diagrams for illustrating positions at which cameras may be mounted on a vehicle and components of the camera in accordance with an embodiment.

FIGS. 4A to 4d are diagrams for illustrating an operation in which a navigation device and an external terminal are communicatively connected according to one embodiment.

FIGS. 5A to 5d are diagrams for illustrating an operation of sharing driving image information according to another embodiment.

FIGS. 6A and 6B are diagrams for illustrating an operation of performing live streaming according to another embodiment.

FIGS. 7A and 7B are diagrams for illustrating an operation of sharing turn-by-turn (TBT) information according to another embodiment.

FIG. 8 is a flowchart of a method for providing a navigation service using the navigation device 1 according to an embodiment.

FIG. 9 is a diagram illustrating a relationship between a server for providing a navigation service, and an external terminal, a user terminal, and a vehicle in accordance with an embodiment of the present invention.

### DETAILED DESCRIPTION OF EMBODIMENTS

A navigation device 1 to be described below not only refers to an independent device constructed separately from a vehicle providing a navigation service only, but also may refer to a device that is implemented as one component of a vehicle and provides a navigation service, and may be interpreted as a concept that includes both a server providing a navigation service and a user terminal providing a navigation service.

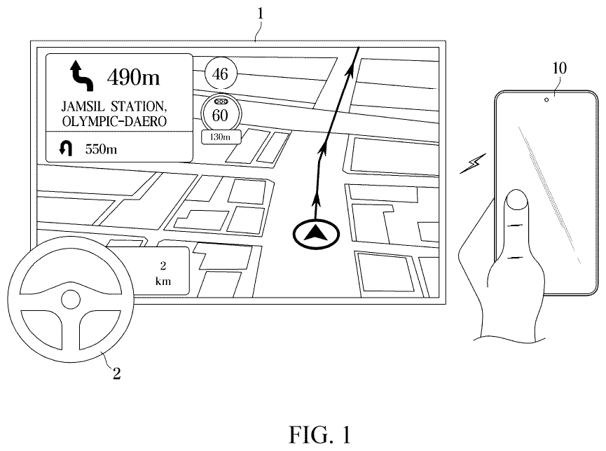

FIG. 1 is a diagram for illustrating the relationship between a navigation device and an external terminal.

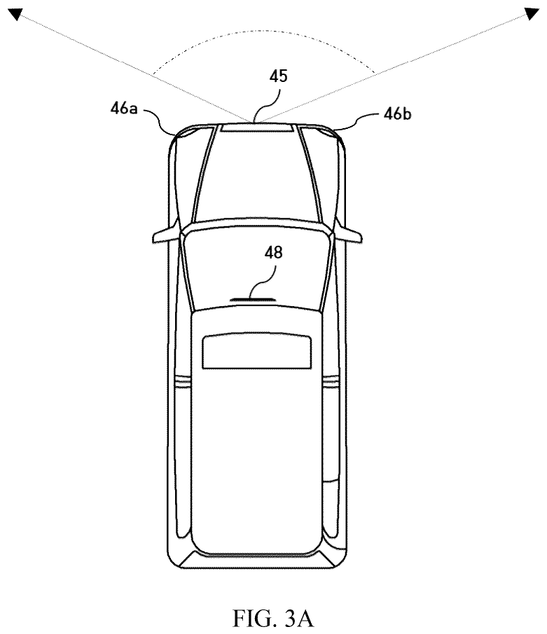

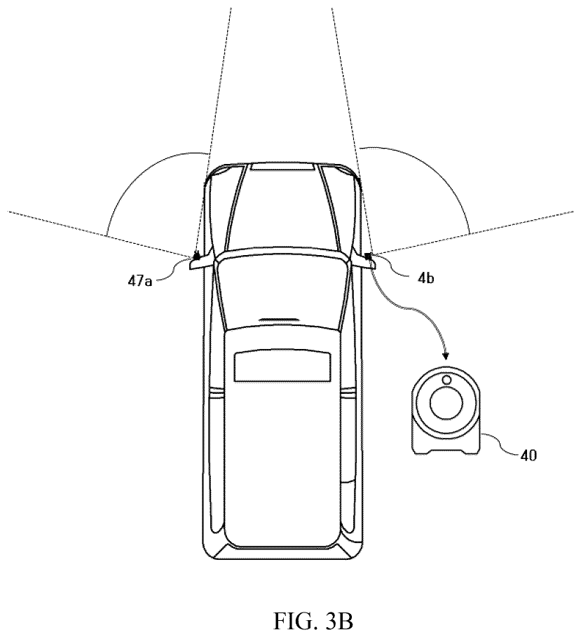

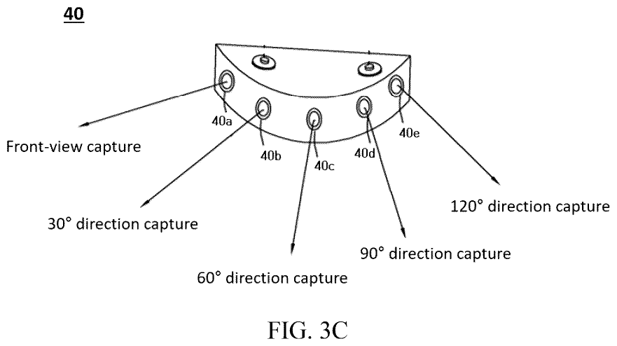

Referring to FIG. 1, a navigation device 1 may be provided near a steering wheel 2 inside a vehicle 5 (refer to FIG. 3A) and can provide guidance to a driver. As illustrated in FIG. 1, the navigation device 1 may display map information on its screen. In particular, the map information displayed by the navigation device 1 may display not only the surrounding terrain and roads but also the driving information of the vehicle received from the vehicle or an external server together. For example, the navigation device may display the traveling speed (46 km/h) of the vehicle 5. In addition, the navigation device 1 can guide a driving route to a destination, and can display the distance (550 m) to a turning point, TBT (turn-by-turn, U-turn information), or the like in combination with the map information.

Meanwhile, the navigation device 1 may communicate with an external terminal 10. The external terminal 10 may be implemented by a computer or a portable terminal capable of connecting to the navigation device 1 through a network. Here, the computer may include, for example, a laptop, a desktop, a tablet PC, a slate PC, and the like with a web browser installed thereon, and the portable terminal is, for example, a wireless communication device that ensures portability and mobility, and may include all types of handheld-based wireless communication devices such as PCS (Personal Communication System), GSM (Global System for Mobile communications), PDC (Personal Digital Cellular), PHS (Personal Handphone System), PDA (Personal Digital Assistant), IMT (International Mobile Telecommunication)-2000, CDMA (Code Division) Multiple Access)-2000, W-CDMA (W-Code Division Multiple Access), WiBro (Wireless Broadband Internet) terminals, smartphones, etc., wearable devices such as watches, rings, bracelets, anklets, necklaces, glasses, contact lenses, or head-mounted-devices (HMDs), and the like.

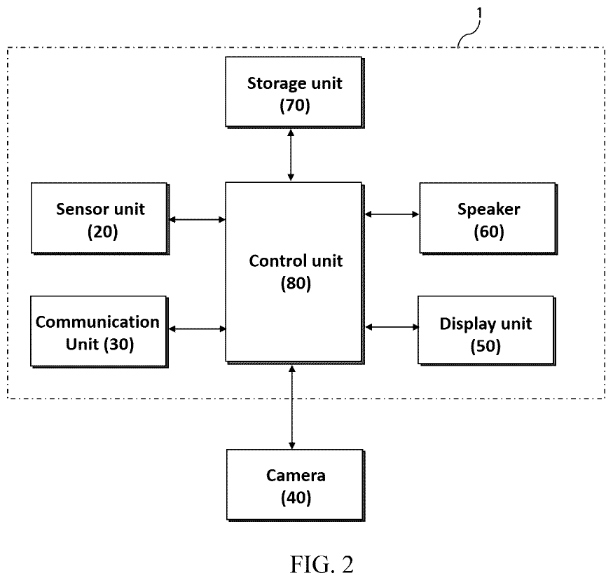

FIG. 2 is a block diagram showing some components of a navigation device in accordance with an embodiment, and FIGS. 3A, 3B and 3C are diagrams for illustrating positions at which cameras may be mounted on a vehicle and components of the camera in accordance with an embodiment.

Referring to FIG. 2, the navigation device 1 may include a sensor unit 20 for recognizing the voice of a user, a communication unit 30 capable of sending and receiving various information to and from an external terminal 10 and an external server (not shown), a display unit 50 that outputs information on a driving route for guiding a vehicle to a destination inputted, driving images of the vehicle captured by cameras 40, information received from the external terminal 10, and other various user interfaces to the outside, a speaker 60 for outputting in sound the guidance required for the driving route and the voice information of the user received from the external terminal 10, a storage unit 70 for having the guidance and map information stored thereon in advance and storing various information received from the vehicle 5 and the external terminal 10, and a control unit 80 that generally controls the components described above, and may communicate with the cameras 40 installed in various positions of the vehicle for capturing images of the front-view, sides, and rear-review of the vehicle 5.

Specifically, the sensor unit 20 may include a collector for recognizing the voice of the user. The sensor unit 20 may include various devices that receive the voice of the user through vibration, amplify it, and then convert it into an electrical signal. The sensor unit 20 converts the voice of the user into an electrical signal and transmits it to the control unit 80. The control unit 80 may recognize the voice of the user through a voice recognition algorithm.

The communication unit 30 may receive and send various information from and to the external terminal 10 or the external server. Specifically, the communication unit 30 may receive various information related to the driving of the vehicle from the external server, or send the driving images of the vehicle captured through at least one camera 40 installed in the vehicle 5 to the external terminal 10, the display unit 50, and the control unit 80.

The driving information received from the external server may generally include driving information to a destination, information on the current traffic conditions, map information, and various information on the road on which the vehicle is currently traveling, and such information is processed so that the driver can conveniently recognize it and is displayed on the display unit 50 as driving information.

The cameras 40 are housing modules installed on the inside/outside or both sides of the vehicle, and may be mounted on at least one of the center 45 of the front bumper of the vehicle so that front-view images of the vehicle can be captured, the headlamps 46A and 46B installed at both ends of the front bumper, the side-view mirrors 47A, 47B, and the rear-view mirror 48 installed inside the vehicle, for example, as shown in FIG. 3, and acquire images of the front and sides of the vehicle 5.

The front-view images captured by the cameras 40 may be stored in the storage unit 70 to be described later, and the storage unit 70 is a module that can input/output information, such as a hard disk drive, a solid-state drive (SSD), flash memory, CF card (Compact Flash card), SD card (Secure Digital card), SM card (Smart Media Card), MMC card (Multi-Media Card), Memory Stick, or the like, and may be provided inside the device or may be provided in a separate device.

The camera 40 may include a lens assembly, a filter, a photoelectric conversion module, and an analog/digital conversion module. The lens assembly includes a zoom lens, a focus lens and a compensating lens. The focal length of the lens may be moved according to the control of a focus motor MF. The filter may include an optical low-pass filter and an infrared cut-off filter. The optical noise of high frequency components is removed with the optical low-pass filter, and the infrared cut-off filter blocks the infrared component of incident light. The photoelectric conversion module may comprise an imaging device, such as a charge-coupled device (CCD), a complementary metal-oxide-semiconductor (CMOS), or the like. The photoelectric conversion module converts light from an optical system (OPS) into an electrical analog signal. The analog/digital conversion module may comprise a CDS-ADC (Correlation Double Sampler and Analog-to-Digital Converter) device.

If the cameras 40 are mounted on the center 45 of the front bumper and on the rear-view mirror 48 of the vehicle as shown in FIG. 3A, front-view images of the vehicle based on the exact center of the vehicle can be acquired, and if mounted on the headlamps 46A and 46B or the side-view mirrors 47A and 47B, information on the front left-view images of the vehicle or the right front-view images of the vehicle can be acquired, as shown in FIG. 3B.

Further, the cameras 40 may be implemented such that a plurality of cameras facing in different directions are installed as shown in FIG. 3C, in addition to the front camera 40a facing forward from the vehicle. For example, there may be provided the front camera 40a facing forward, a 30° camera 40b facing the 30° direction based on the forward direction, a 60° camera 40c facing the 60° direction based on the forward direction, a 90° camera 40d facing the 90° direction based on the forward direction, and a 120° camera 40e facing the 120° direction based on the forward direction.

Therefore, the front camera 40a can capture front-view images in the forward direction, the 30° camera 40b can capture 30° images, which are images in the 30° direction based on the forward direction, the 60° camera 40c can capture 60° images, which are images in the 60° direction based on the forward direction, the 90° camera 40d can capture 90° images, which are images in the 90° direction based on the forward direction, and the 120° camera 40e can capture 120° images, which are images in the 120° direction based on the forward direction, and the images thus captured may be displayed on the display unit 50 or transmitted to the external terminal 10. Accordingly, the user may share not only images of the front view of the vehicle but also side images of the vehicle with the external terminal 10, and may receive driving assistance information from the external terminal 10 based on the images sent. A detailed description thereof will be provided later.

The various images acquired by the cameras 40 may be sent to the display unit 50 and displayed together with the image in the vehicle driving information, and may be sent to the external terminal 10 via the communication unit 30.

The driving image acquired by the cameras 40 displayed on the display unit 50 may be generally an image of the front view of the vehicle centered on the exact center of the vehicle, but an image for the left or right side of the vehicle or an image of the rear-view may be displayed at the request of the driver of the vehicle or the external terminal 10.

In addition, the communication unit 30 may receive the voice information of an external user sent by the external terminal 10, or driving assistance information received as input from the user of the external terminal for the driving image captured by the cameras 40 displayed on the external terminal 10, and the like, and the received information may be transmitted to the control unit 80.

Therefore, the communication unit 30 may include one or more components that send and receive signals to and from various components of the vehicle 5 and enable communication with the external server and the external terminal 10. For example, it may include at least one of a short-range communication module, a wired communication module, and a wireless communication module.

The short-range communication module may include various short-range communication modules for sending and receiving signals by using a wireless communication network in a short distance, such as a Bluetooth module, an infrared communication module, an RFID (Radio Frequency Identification) communication module, a WLAN (Wireless Local Access Network) communication module, an NFC communication module, a Zigbee communication module, etc.

The wired communication module may include not only various wired communication modules, such as a Controller Area Network (CAN) communication module, a Local Area Network (LAN) module, a Wide Area Network (WAN) module, or a Value-Added Network (VAN) module, but also various cable communication modules, such as USB (Universal Serial Bus), HDMI (High-Definition Multimedia Interface), DVI (Digital Visual Interface), RS-232 (recommended standard232), power line communication, or POTS (plain old telephone service).

The wireless communication module may include a wireless communication module supporting various wireless communication methods, such as GSM (Global System for Mobile Communication), CDMA (Code Division Multiple Access), WCDMA (Wideband Code Division Multiple Access), UMTS (universal mobile telecommunications system), TDMA (Time Division Multiple Access), or LTE (Long Term Evolution), in addition to a Wi-Fi module and a Wireless broadband module.

The display unit 50 is configured with a display, and displays driving route information obtained by visually configuring driving routes, driving speeds of the vehicle, map information, and guidance. In addition, the display unit 50 may display thereon map information and driving information received from the external server, vehicle traveling images captured by the cameras 40 attached to the vehicle, and driving assistance information received from the external terminal 10, etc.

The display may include various display panels, such as a liquid crystal display (LCD) panel, a light-emitting diode (LED) panel, or an organic light-emitting diode (OLED) panel. Meanwhile, if the display includes a graphical user interface (GUI) such as a touchpad or the like, that is, a device that is software, it may also serve as an input unit for receiving user input.

In one embodiment, a touch input displayed by the driver of the vehicle of the display unit 50 provided as a touchpad may be received, and an arrow or text corresponding thereto may be displayed. The display unit 50 converts an input command of the user into an electrical signal and transmits it to the communication unit 30. In addition, the display unit 50 may receive image information including arrows and text from the communication unit 30 based on a touch input inputted by the user of the external terminal 10 and display the information received.

The speaker 60 may include a component for outputting guidance in a sound.

The speaker 60 in accordance with an embodiment may present various voice information, in addition to outputting guidance. For example, if the sensor unit 20 receives an input command through the voice of the driver, the control unit 80 may recognize the voice command of the user through a voice recognition algorithm, and output an answer corresponding thereto through the speaker 60. In other words, the speaker 60 may output a voice answer stored in advance.

As another embodiment, the speaker 60 may output voice information inputted by the user of the external terminal 10 received by the communication unit 30. In other words, the navigation device 1 may provide guidance just like a streaming service by outputting voice information on a driving route sent by the user of the external terminal 10 through the external terminal 10.

The storage unit 70 stores various information received by the communication unit 30 and programs necessary for the operation of the navigation device 1. Specifically, the information to be stored by the storage unit 70 may include information provided by the vehicle 5, and driving assistance information including display information and voice information sent by the external terminal 10. The storage unit 70 provides information necessary when the control unit 80 operates based on the input command of the user. In addition, the storage unit 70 may have map information stored thereon in advance, and provide the map information for the control unit 80 to search for driving routes to reach a destination. The map information may include information about terrain features.

The storage unit 70 may store information necessary for guidance. For example, the storage unit 70 stores the guidance “Turn right” in the form of data. When the location of the vehicle approaches within a certain distance on the driving route based on the GPS signal, the control unit 80 may provide guidance to the driver by outputting the guidance.

Therefore, the storage unit 70 may be implemented by at least one of non-volatile memory devices, such as cache, read-only memory (ROM), programmable ROM (PROM), erasable programmable ROM (EPROM), electrically erasable programmable ROM (EEPROM), and flash memory, or volatile memory devices, such as random-access memory (RAM), or storage media, such as a hard disk drive (HDD) or CD-ROM, but the present invention is not limited thereto. The storage unit 70 may be a memory implemented as a chip separate from the processor described above in relation to the control unit 80 to be described later, or may be implemented as a chip integral with the processor.

The control unit 80 controls the navigation device 1 on the whole.

Specifically, the control unit 80 performs a basic operation of navigation for controlling the display unit 50 and the speaker 60 in order to guide the driver along the driving route based on the map information and the GPS signal of the vehicle 5.

The control unit 80 may receive via the communication unit 30 the driving assistance information sent by the external terminal 10 for the driving image shared with the external terminal 10, and may display the received driving assistance information on the display unit 50 together with the driving image captured by the cameras 40 or driving route information, or may control the speaker 60 so that the driving assistance information may be outputted through the speaker 60.

In addition, when the vehicle 5 and the external terminal 10 are communicatively connected at the request of the external terminal 10, the control unit 80 may control such that the driving image of the vehicle sent by the communication unit 30 to the external terminal can be displayed also on the display unit 50 at the same time.

If the driving image of the vehicle sent to the external terminal 10 is displayed on the display unit 50, the driver may be provided with guidance much like a streaming service that receives road guidance while watching the same image as the user of the external terminal 10.

The driving assistance information refers to information inputted by the user of the external terminal 10 in response to the driving image and driving route information of the vehicle shared with the external terminal 10 via the communication unit 30. The driving assistance information received as input from the user of the external terminal for the image may refer to display information or voice information. The display information and the voice information may refer to travel information to travel in a particular direction.

Meanwhile, the control unit 80 may be implemented by a memory (not shown) that stores data for an algorithm for controlling the operation of the components of the navigation device 1 or a program that reproduces the algorithm, and a processor (not shown) that performs the operation described above using the data stored in the memory. In this case, the memory and the processor may each be implemented by separate chips. Alternatively, the memory and the processor may also be implemented by a single chip.

Further, although the control unit 80 and the communication unit 30 are illustrated as separate components in FIG. 2, these are illustrated separately for the convenience of description, and the present invention may be implemented with the control unit 80 and the communication unit 30 combined into a single component.

The navigation device 1 may further include other components in addition to the components described above in FIG. 2, and may be provided with components necessary for the operation described above without being bound by their names.

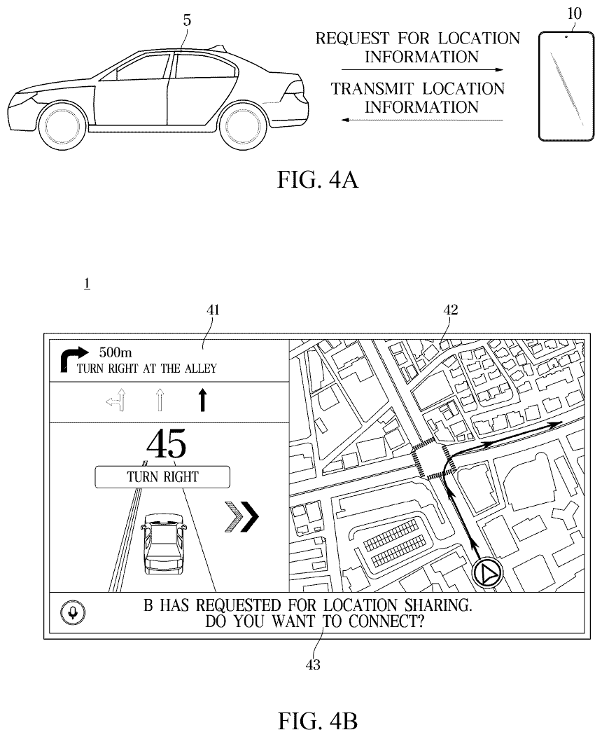

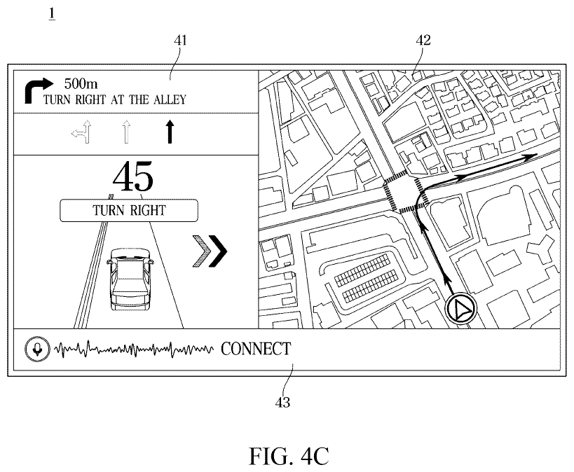

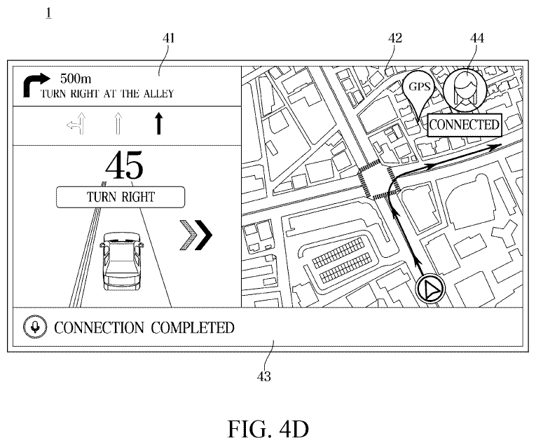

FIGS. 4A to 4d are diagrams for illustrating an operation in which a navigation device and an external terminal are communicatively connected according to one embodiment. In order to avoid repetitive descriptions, they will be described together below.

Referring to FIG. 4A, the vehicle 5 provided with the navigation device 1 may share location information with the external terminal 10 while traveling.

In more detail, when a request for location information is received from the external terminal 10 while traveling, the navigation device 1 may send the location information of the current vehicle to the external terminal 10. The navigation device 1 may perform wireless communication using an antenna provided in the vehicle 5, or may also communicate with the external terminal 10 using the communication unit 30, and the location information may include GPS signal information of the current vehicle.

Referring to FIG. 4B, the navigation device 1 may divide and display on the display unit 50 a first display area 41 for displaying the driving route of the vehicle 5 and a second display area 42 for displaying the map information, and may display a third display area 43 that displays in the text the guidance voice informing the process of sharing the location information. The information encompassing all information displayed on the first display area 41 and the second display area 42 may be referred to as driving information.

The navigation device 1 may also receive a location-sharing request from the external terminal 10, as shown in FIG. 4B. In this case, the navigation device 1 may output in sound or display the guidance “Location sharing of B has been requested. Do you want to connect?”

As shown in FIG. 4C, when a request for sharing location information from the external terminal 10 comes, a user input for approving the request may be inputted by voice. The navigation device 1 may receive the voice input for the approval by the user via the sensor unit 20. For example, the driver may input “connect,” and the navigation device 1 may determine that sharing of the location information is approved through a voice recognition algorithm. In addition, the navigation device 1 may also display the result of recognizing the voice input of the user by the navigation device 1 on the third display area 43 by displaying the text ‘connect’ via the display unit 50.

Referring to FIG. 4d, the navigation device 1 may share the location information with the external terminal 10 based on the approval by the user. When the location information is sent, the navigation device 1 may display the text “connected” on the third display area 43, and display a photo of the user of the terminal 10, that is, B, or an icon 44 together on the map information in the second display area 42. Through this, the driver may recognize that the navigation device 1 shares the location information with the external terminal 10.

Meanwhile, the screens of the first to third display areas 41 to 43 in FIGS. 4B to 4d are merely examples, and may include various modifications.

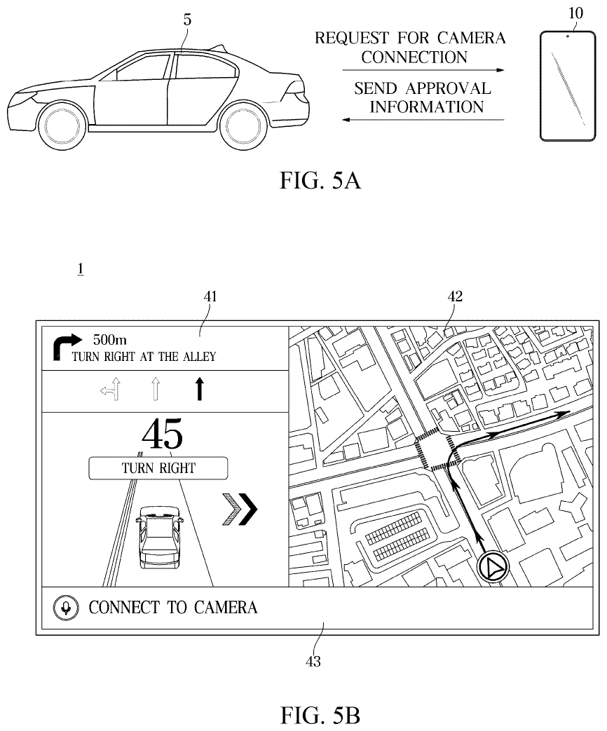

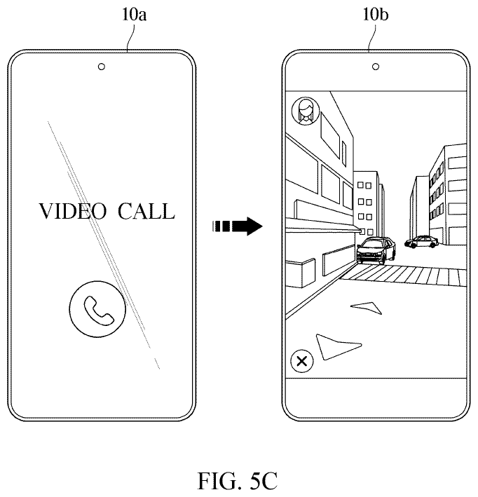

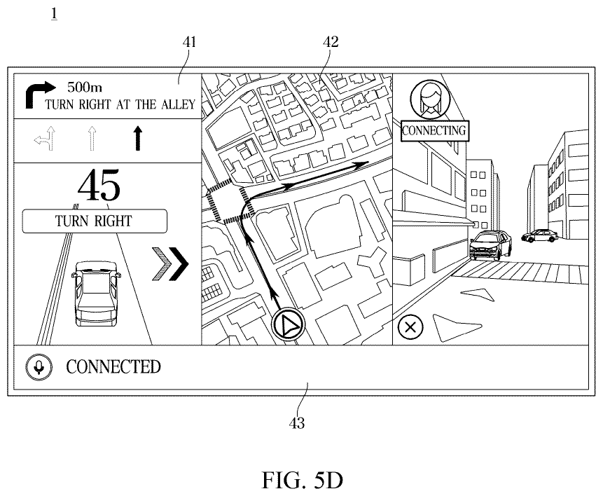

FIGS. 5A to 5d are diagrams for illustrating an operation of sharing driving image information according to another embodiment. In order to avoid repetitive descriptions, they will be described together below.

Referring to FIG. 5A first, the navigation device 1 may share various image information with the external terminal 10. Specifically, it is possible to share driving images for various directions of the vehicle captured via at least one camera 400 installed in the vehicle, and an image for driving route information of the vehicle displayed on the display unit 50 can also be shared.

In more detail, the navigation device 1 may send a signal requesting camera connection to the external terminal 10, and, if the external terminal 10 agrees to this, may send the driving image and the image for the driving route information described above to the external terminal 10.

Referring to FIG. 5B, the navigation device 1 may receive an input command requesting sharing of image information with the external terminal 10 from the driver or passenger inside the vehicle 5. As an example, the navigation device 1 may receive a voice command of the driver from the sensor unit 20. If the driver inputs a voice command “Connect to the camera,” the navigation device 1 may determine this as a request for sharing the image information.

The navigation device 1 may display the result of recognizing the voice input by the driver, that is, “Connect to the camera” in the text on the third display area 43. Thereafter, the navigation device 1 may send various image information to the external terminal 10.

FIG. 5C illustrates a user interface through which the external terminal 10 connects a video call according to a request signal from the navigation device 1. As an example, the external terminal 10 may recognize the request signal of the navigation device 1 as a video call connection, and may ask the user whether to approve the connection via a user interface 10a such as a video call connection.

If the external user agrees to the connection, the driving image or the image for the driving information of the vehicle sent by the navigation device 1 may be displayed on the display of the external terminal 10.

When the navigation device 1 sends the driving image captured by the cameras 40 to the external terminal 10, the driving route of the vehicle may be displayed on the first display area 41 of the navigation device 1, the map information may be displayed on the second display area 42, and the driving image sent to the external terminal 10 may be simultaneously displayed on the fourth display area 45, as shown in FIG. 5d. In addition, the navigation device 1 may output a text or sound that can inform the driver of the reception of image information, that is, “Connected,” to the third display area 43. If the driving image sent to the external terminal 10 is displayed at the same time, the driver can be more easily provided with information on the travel route to the destination from the user of the external terminal 10 because the driver and the user of the external terminal 10 are viewing the same image.

Meanwhile, the screens of the first to fourth display areas 41 to 44 and the user interface of the external terminal 10 noted in FIGS. 5B to 5d are merely examples, and may include various modifications.

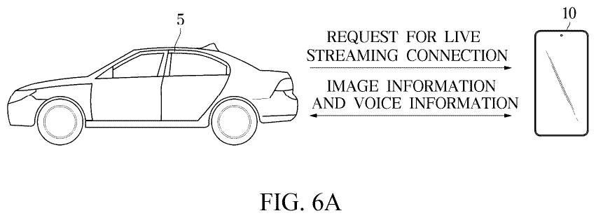

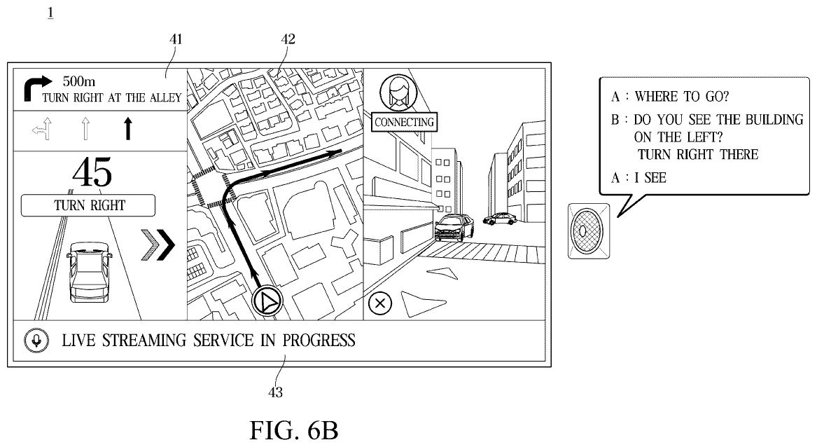

FIGS. 6A and 6B are diagrams for illustrating an operation of performing live streaming according to another embodiment. In order to avoid repetitive descriptions, they will be described together below.

Referring to FIG. 6A, the navigation device 1 may perform live streaming of sending and receiving information to and from the external terminal 10 in real-time, unlike FIG. 5A. Specifically, the navigation device 1 may request a streaming connection from the external terminal 10, and the external terminal 10 may approve this, or on the contrary, the external terminal 10 may request this and the navigation device 1 may approve it. In this case, the navigation device 1 and the terminal 10 may send and receive image information and audio information in both directions.

FIG. 6B illustrates an embodiment in which the navigation device 1 and the terminal 10 send and receive image information and audio information through streaming. In more detail, when a connection with the terminal 10 is established, the navigation device 1 may output the text and voice “Live streaming service in progress” to the third display area 43.

The navigation device 1 may simultaneously display the driving image of the vehicle captured by the camera 40, which is being sent to the external terminal 10, on the fourth display area 45. Image information that changes as the vehicle 5 moves may also be displayed together while changing in real-time. In such a case, since the image currently being viewed by the driver of the vehicle and the image being viewed by the user of the external terminal 10 are the same, there is an advantage that information on the driving direction can be easily obtained from an external user who knows the geography well.

Further, the navigation device 1 and the terminal 10 may output the received voice information while sending and receiving voice information to and from each other. For example, the driver A may transmit voice information “where to go?” to the external terminal 10. The user B of the external terminal 10 may transmit a voice saying “Do you see the building on the left? Turn left there,” and the navigation device 1 may output the received voice information via the speaker 60. The navigation device 1 receives the voice of the driver A saying “I see” and transmits it to the external terminal 10.

Through this, since the navigation device 1 can be provided with guidance in conversation as if the user was giving directions from next to the driver while the driver and the user view the same screen in real-time, there is an effect that the driver of the vehicle can drive to the destination more accurately.

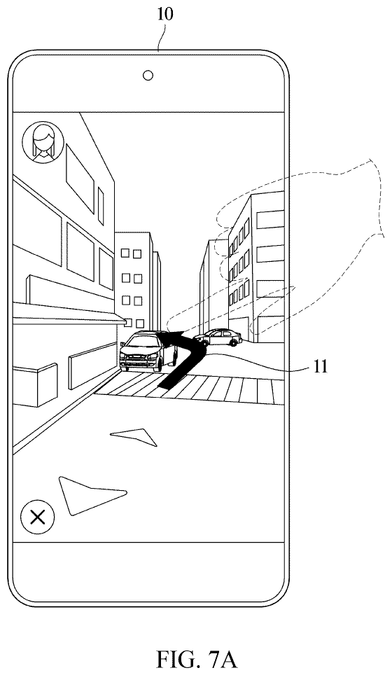

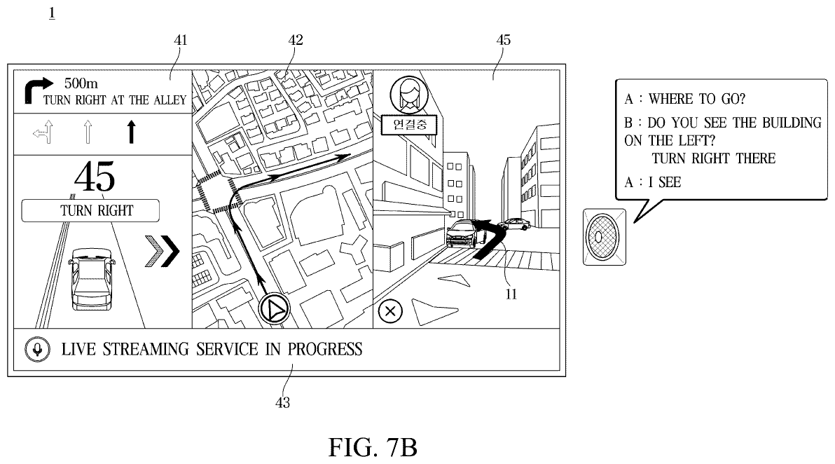

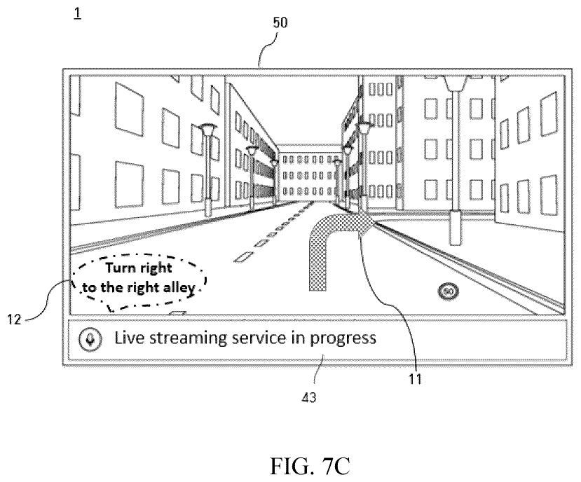

FIGS. 7A and 7B are diagrams for illustrating an operation of sharing turn-by-turn (TBT) information according to another embodiment. In order to avoid repetitive descriptions, they will be described together below.

As with FIGS. 6A and 6B, the navigation device 1 and the external terminal 10 are proceeding with live streaming in FIG. 7. At this time, the user of the external terminal 10 may send driving assistance information, which is the information about the driving direction, to the driver of the vehicle, and as an example, the user of the external terminal 10 may input information indicating a left turn into the external terminal 10 by using the touch of the user. In such a case, the external terminal 10 may recognize the information inputted by the user by touch as display information, and send the display information to the navigation device 1. The navigation device 1 that has received the display information may generate a first display information 11 obtained by transforming the display information into a left turn arrow, which is a symbol indicating a left turn, as shown in FIG. 7A, and combine the generated first display information with the driving image, and then display the combined image on the display unit 50.

Although an example in which the first display information is transformed into an arrow has been given in FIG. 7A, embodiments of the present invention are not limited thereto and may be transformed into other symbols, text, or the like, and the display information inputted by the user by touch may also be displayed on the display unit 50 as it is.

Referring to FIG. 7B, the navigation device 1 may receive the driving assistance information inputted by the external user into the external terminal 10, and display the received information together with the driving image on the display unit. Specifically, the driving assistance information including the arrow information may be displayed on the fourth display area 45 together with the driving image of the vehicle, as shown in FIG. 7B. Although the driving assistance information is represented by an arrow in FIG. 7B, the driving assistance information is not limited to the arrow and may also be displayed as text or figures depending on driving conditions.

When displaying on the fourth display area in a method of superimposing the driving assistance information over the driving image of the vehicle, as shown in FIG. 7B, because the user can recognize the driving route more accurately, there is an advantage that the driver can receive additionally the information displayed on the screen of the display unit 50 along with the voice information received from the external user, thereby gaining confidence in the route to be taken.

Although the driving assistance information received from the external terminal 10 has been described as being limited to the information received based on the driving image of the vehicle in FIG. 7, embodiments of the present invention are not limited thereto, and if the communication unit 30 has sent the driving route information of the current vehicle to the external terminal 10, the driving assistance information sent by the external user based on the driving route information may be received, a combined image may be generated in a method of superimposing the received driving assistance information over the driving route information displayed on the display unit 50, and the generated combined image may be displayed on the display unit.

For example, if the information displayed in the second display area 42 in FIG. 7B is sent to the external terminal 10, the user of the external terminal 10 may input driving assistance information based on the information received, and the navigation device 1 may receive such information and then display it on the display unit 50.

Further, in the embodiment of FIGS. 7A and 7B, the navigation device 1 may receive a touch input such as an arrow inputted by the driver, display it on the image information displayed by the navigation device 1, and at the same time, send the image information including the arrow information inputted by the driver to the external terminal 10. The user of the external terminal 10 may check the direction information recognized by the driver by looking at the received image information, and may send the driving assistance information to the navigation device 1 again if the driver of the vehicle incorrectly recognizes it.

FIG. 7C is a view showing the TBT information displayed on the display unit in an augmented reality method according to another embodiment.

Referring to FIG. 7C, the navigation device 1 may transform the display information inputted by the user of the external terminal 10 into an arrow or text to generate first display information 11, may convert the voice information inputted by the user of the external terminal 10 into text information to generate second display information 12, and may augment and display the first display information 11 and the second display information 12 onto the driving image displayed on the display unit 50. As an example, if the user of the external terminal 10 inputs display information with the meaning of turning right into the external terminal 10 and simultaneously inputs the voice information ‘Turn right to the right alley’ into the external terminal 10, the navigation device 1 may generate the display information into first display information 11 having the shape of a right arrow, recognize the voice information and then convert it to generate second display information 12, which is text information “Turn right’ (12), and may augment and display the generated first display information 11 and second display information 12 onto the driving image.

Augmented reality (AR) refers to a technology that overlays a 3D virtual image on a real image or background and shows it as a single image. Augmented reality is also called Mixed Reality (MR).

When described with reference to FIG. 7C, the driving image of the current vehicle is displayed as it is on the display unit 50, and the navigation device 1 may generate the driving assistance information inputted by the user of the external terminal 10 into the first display information 11 and the second display information 12 that are virtual images, on the driving image of the vehicle, and may display the first display information 11 and the second display information 12 on the display unit 50 in a method of augmenting them onto the driving image. If the first display information 11 and the second display information 12 are augmented and displayed as a virtual image on the driving image, which is a real image, according to an embodiment of the present invention, there is an effect that the user can more intuitively recognize the direction in which to drive.

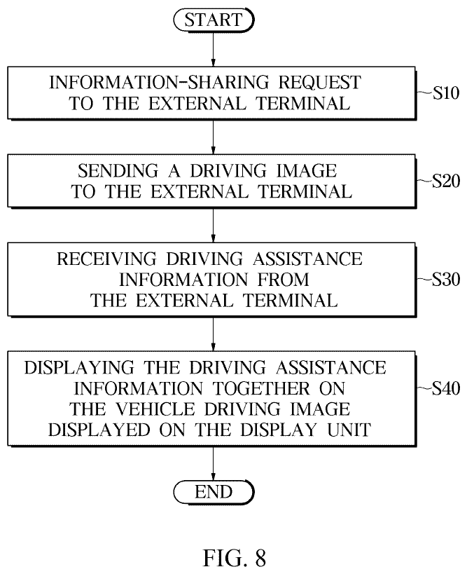

FIG. 8 is a flowchart of a method for providing a navigation service using the navigation device 1 according to an embodiment.

Referring to FIG. 8, the navigation device 1 may send an information-sharing request to the external terminal 10 (S10).

When the external terminal 10 that has received the request signal approves the sharing, the navigation device 1 may transmit a driving image of the vehicle, image information including driving information of the vehicle, and the like to the external terminal 10 (S20).

Thereafter, the navigation device 1 may receive driving assistance information from the external terminal 10 (S30). As the detailed description of the driving assistance information has been described above, it will be omitted.

Thereafter, the navigation device 1 may display the driving assistance information on the vehicle driving image displayed on the display unit 50 together, or output it via the speaker 60 (S40).

The navigation device 1 may display the driving assistance information by superimposing it over the map information, but is not necessarily limited thereto, and the driving assistance information may be provided to the driver in various ways.

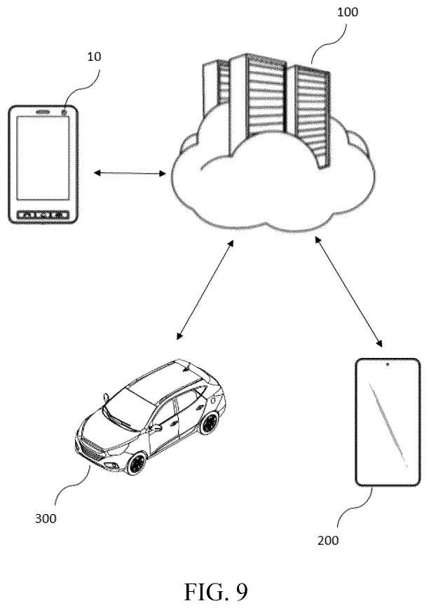

FIG. 9 is a diagram illustrating a relationship between a server for providing a navigation service, and an external terminal, a user terminal, and a vehicle in accordance with an embodiment of the present invention.

Specifically, FIG. 9 is a diagram showing the relationship between a server for providing navigation 100 and an external terminal 10, a user terminal 200, a vehicle 300, and the like, in the case that the execution subject of the navigation guidance service described above with reference to FIGS. 1 to 8 is implemented by the server for providing a navigation service 100. The server for providing navigation 100 may include at least some of the components in the navigation device described with reference to FIG. 2.

The server for providing a navigation service 100 according to FIG. 9 may receive a driving image of the vehicle captured by cameras installed in the vehicle 300 or the user terminal 200, send the received driving image to the external terminal 10, and receive driving assistance information inputted for the driving image from the external terminal 10.

The server for providing a navigation service 100 that has received the driving assistance information may send the information generated based on the assistance information and the driving image for the vehicle to the user terminal 200 or the vehicle 300 that provides the navigation service to the driver. In this case, the server may generate a combined image in a method of superimposing the assistance information over the driving image and then send the generated combined image, and in sending the combined image, may send driving information, which is driving guidance service information for the vehicle, together. Since the method of utilizing the driving assistance information has been described in detail in the previous drawings, a description thereof will be omitted.

Further, the server for providing a navigation service 100 according to FIG. 9 may send not only the navigation service described in the previous drawings but also information on a basic navigation guidance service related to the driving route of the vehicle to the user terminal 200 or the vehicle 300.

As the server described in FIG. 9 refers to a conventional server, the server is computer hardware on which a program is running, and may monitor and control the entire network, such as printer control or file management, or may support connection with other networks via mainframes or public networks, or sharing of software resources such as data, programs, and files, or hardware resources such as modems, fax machines, printer sharing, other equipment, and the like.

According to the navigation device, the method for providing a navigation service, and the server for providing a navigation service in accordance with an embodiment, since a driver can receive guidance for a driving route from an external user while the user of an external terminal is viewing the same driving image, there is an effect of reducing the error between the current location recognized by the driver and a destination and of improving the reliability of the navigation device.

In addition, according to the navigation device, the method for providing a navigation service, and the server for providing a navigation service in accordance with an embodiment, there is an advantage that when a driver drives to a destination, he or she can receive guidance of voice information or input information from another person who knows the route to the destination well together, and thus, can drive to the destination more safely.

On the other hand, the constitutional elements, units, modules, components, and the like stated as “˜part or portion” in the present invention may be implemented together or individually as logic devices interoperable while being individual. Descriptions of different features of modules, units or the like are intended to emphasize functional embodiments different from each other and do not necessarily mean that the embodiments should be realized by individual hardware or software components. Rather, the functions related to one or more modules or units may be performed by individual hardware or software components or integrated in common or individual hardware or software components.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof.

The processes and logic flows described in this specification can be performed by one or more programmable processors executing one or more computer programs to perform functions by operating on input data and generating output.

This written description sets forth the best mode of the present invention and provides examples to describe the present invention and to enable a person of ordinary skill in the art to make and use the present invention. This written description does not limit the present invention to the specific terms set forth.

While the present invention has been shown and described with reference to certain embodiments thereof, it will be understood by those skilled in the art that various changes in forms and details may be made therein without departing from the spirit and scope of the present invention as defined by the appended claims and their equivalents. Therefore, the technical scope of the present invention may be determined by on the technical scope of the accompanying claims.

What is claimed is:

1. A navigation device comprising:
a communication unit configured to send a driving image of a vehicle captured through at least one camera installed in the vehicle to an external terminal, and to receive driving assistance information inputted to the external terminal for the driving image; and
a control unit configured to output information generated based on the driving assistance information by controlling at least one of a display unit and a speaker.

2. The navigation device of claim 1, wherein the driving assistance information comprises display information inputted by a user of the external terminal for the driving image displayed on the external terminal, and
the control unit displays the display information on the display unit together with the driving image displayed on the display unit.

3. The navigation device of claim 1, wherein the control unit displays first display information, obtained by transforming the driving assistance information into arrows or text, by superimposing or augmenting it over the driving image.

4. The navigation device of claim 2, wherein the control unit displays the display information by superimposing or augmenting it over the driving image, without transforming it.

5. The navigation device of claim 1, wherein the control unit displays driving route information for guiding the vehicle on the display unit.

6. The navigation device of claim 5, wherein the communication unit sends the driving route information to the external terminal, and
the control unit displays driving assistance information inputted from the external terminal for the driving route information displayed on the external terminal together with the driving route information displayed on the display unit.

7. The navigation device of claim 1, wherein if the driving assistance information is voice information, the control unit outputs the voice information through a speaker.

8. The navigation device of claim 1, wherein if the external terminal and the communication unit are connected, the control unit simultaneously displays the driving image of the vehicle sent by the communication unit to the external terminal on the display unit.

9. A method for providing a navigation service, comprising:
receiving driving information of a vehicle and a driving image of the vehicle, and sending the driving image to an external terminal;
receiving driving assistance information inputted to the external terminal for the driving image sent to the external terminal; and
generating a combined image obtained by combining the driving assistance information with the driving image, and sending the combined image to the vehicle or a user terminal providing a driving information service for the vehicle.

10. A server for providing a navigation service, comprising:
a communication unit configured to receive a driving image of a vehicle, to send the driving image to an external terminal, and then to receive driving assistance information inputted by the external terminal for the driving image; and
a control unit configured to generate a combined image obtained by combining the driving assistance information with the driving image, and to send, by using the communication unit, the combined image and driving route information for guiding the vehicle to the vehicle or a user terminal providing a driving information service for the vehicle.
